(19) United States
(12) Patent Application Publication
(10) Pub. No.: US 2021/0103400 A1
(43) Pub. Date: Apr. 8, 2021

(54) STORAGE SYSTEM AND DATA MIGRATION METHOD

(71) Applicant: Hitachi, Ltd., Tokyo (JP)

(72) Inventors: Yuto KAMO, Tokyo (JP); Takayuki FUKATANI, Tokyo (JP); Mitsuo HAYASAKA, Tokyo (JP)

(21) Appl. No.: 16/783,438

(22) Filed: Feb. 6, 2020

(30) Foreign Application Priority Data
Oct. 7, 2019 (JP) 2019-184724

(51) Int. Cl. G06F 3/06

(52) U.S. Cl. CPC G06F 3/0647; G06F 3/0653; G06F 3/0604; G06F 3/0673; G06F 3/0644; G06F 3/0659

(57) ABSTRACT

A storage system and a data migration method that appropriately migrate data without adding a device are provided. The storage system includes one or more nodes. A data migration section instructs a data processing section to migrate data of a migration source system to a migration destination system. When the data processing section receives the instruction to migrate the data, and stub information of the data exists, the data processing section reads the data from the migration source system based on the stub information, instructs the migration destination system to write the data, and deletes the stub information. When the migration of the data is completed, the data migration section instructs the migration source system to delete the data.

### CROSS-REFERENCE TO RELATED APPLICATION

The present application claims priority from Japanese application JP 2019-184724, filed on Oct. 7, 2019, the contents of which is hereby incorporated by reference into this application.

### BACKGROUND

The present invention relates to a storage system and a data migration method, and is suitable to be applied to a storage system and a data migration method, which enable data to be migrated from a migration source system to a migration destination system.

When a storage system user replaces an old system with a new system, data needs to be synchronized between the systems to take over a workload. Recent storage media have significantly larger capacities than before. Thus, it takes long time to synchronize the data between the old and new systems. In some cases, it takes one week or more to synchronize the data between the old and new systems. The user does not consider to stop a business task for such a longtime and may consider to continue the business task during the synchronization.

A technique for transferring a received request to a migration source file system and a migration destination file system during data synchronization from the migration source file system to the migration destination file system and transferring a received request to the migration destination file system after the completion of the synchronization to suppress a time period for stopping a business task during migration between the file systems has been disclosed (refer to U.S. Pat. No. 9,311,314).

In addition, a technique for generating a stub file and switching an access destination to a migration destination file system before migration for the purpose of reducing a time period for stopping a business task during confirmation of synchronization has been proposed (refer to U.S. Pat. No. 8,856,073).

### SUMMARY

Scale-out file software-defined storage (SDS) is widely used for corporate private clouds. For the file SDS, data needs to be migrated to a system, which is of a different type and is not backward compatible, in response to upgrade of a software version, the end of life (EOL) of a product, or the like in some cases.

The file SDS is composed of several tens to several thousands of general-purpose servers. It is not practical to separately prepare a device that realizes the same performance and the same capacity upon data migration due to cost and physical restrictions.

However, in each of the techniques described in U.S. Pat. No. 9,311,314 and U.S. Pat. No. 8,856,073, it is assumed that a migration source and a migration destination are separate devices. It is necessary to prepare, as the migration destination device, a device equivalent to or greater than the migration source. If the same device as the migration source is used as the migration destination, the migration source and the migration destination have duplicate data during migration in each of the techniques described in U.S. Pat. No. 9,311,314 and U.S. Pat. No. 8,856,073. When the total of a capacity of the migration source and a capacity of the migration destination is larger than a physical capacity, an available capacity becomes insufficient and the migration fails.

The invention has been devised in consideration of the foregoing circumstances, and an object of the invention is to propose a storage system and the like that can appropriately migrate data without adding a device.

To solve the foregoing problems, according to the invention, a storage system includes one or more nodes, and each of the one or more nodes stores data managed in the system and includes a data migration section that controls migration of the data managed in a migration source system from the migration source system configured using the one or more nodes to a migration destination system configured using the one or more nodes, and a data processing section that generates, in the migration destination system, stub information including information indicating a storage destination of the data in the migration source system. The data migration section instructs the data processing section to migrate the data of the migration source system to the migration destination system. When the data processing section receives the instruction to migrate the data, and the stub information of the data exists, the data processing section reads the data from the migration source system based on the stub information, instructs the migration destination system to write the data, and deletes the stub information. When the migration of the data is completed, the data migration section instructs the migration source system to delete the data.

In the foregoing configuration, data that is not yet migrated is read from the migration source system using the stub information. When the data is written to the migration destination system, the data is deleted from the migration source system. According to the configuration, the storage system can avoid holding duplicate data and migrate data from the migration source system to the migration destination system using an existing device, while a user does not add a device in order to migrate the data from the migration source system to the migration destination system.

According to the invention, data can be appropriately migrated without adding a device. Challenges, configurations, and effects other than the foregoing are clarified from the following description of embodiments.

### BRIEF DESCRIPTION OF THE DRAWINGS

FIG. 1 is a diagram describing an overview of a storage system according to a first embodiment.

FIG. 2 is a diagram illustrating an example of a configuration related to the storage system according to the first embodiment.

FIG. 3 is a diagram illustrating an example of a configuration related to a host computer according to the first embodiment.

FIG. 4 is a diagram illustrating an example of a configuration related to a management system according to the first embodiment.

FIG. 5 is a diagram illustrating an example of a configuration related to a node according to the first embodiment.

FIG. 6 is a diagram illustrating an implementation example of distributed FSs that use a stub file according to the first embodiment.

FIG. 7 is a diagram illustrating an example of a configuration related to the stub file according to the first embodiment.

FIG. 8 is a diagram illustrating an example of a data structure of a migration source file management table according to the first embodiment.

FIG. 9 is a diagram illustrating an example of a data structure of a physical pool management table according to the first embodiment.

FIG. 10 is a diagram illustrating an example of a data structure of a page allocation management table according to the first embodiment.

FIG. 11 is a diagram illustrating an example of a data structure of a migration management table according to the first embodiment.

FIG. 12 is a diagram illustrating an example of a data structure of a migration file management table according to the first embodiment.

FIG. 13 is a diagram illustrating an example of a data structure of a migration source volume release region management table according to the first embodiment.

FIG. 14 is a diagram illustrating an example of a data structure of a node capacity management table according to the first embodiment.

FIG. 15 is a diagram illustrating an example of a flowchart related to a distributed FS migration process according to the first embodiment.

FIG. 16 is a diagram illustrating an example of a flowchart related to a file migration process according to the first embodiment.

FIG. 17 is a diagram illustrating an example of a flowchart related to a page release process according to the first embodiment.

FIG. 18 is a diagram illustrating an example of a flowchart related to a stub management process according to the first embodiment.

FIG. 19 is a diagram describing an overview of a storage system according to a second embodiment.

### DETAILED DESCRIPTION

Hereinafter, embodiments of the invention are described in detail with reference to the accompanying drawings. In the embodiments, a technique for migrating data from a system (migration source system) of a migration source to a system (migration destination system) of a migration destination without adding a device (a storage medium, a storage array, and/or a node) for data migration is described.

The migration source system and the migration destination system may be distributed systems or may not be distributed systems. Units of data managed in the migration source system and the migration destination system may be blocks, files, or objects. The embodiments describe an example in which the migration source system and the migration destination system are distributed file systems (distributed FSs).

In each of storage systems according to the embodiments, before the migration of a file, a stub file that enables the concerned file to be accessed is generated in an existing node (same device) instead of the concerned file, and an access destination is switched to the migration destination distributed FS. In each of the storage systems, a file completely migrated is deleted from the migration source distributed FS during a migration process.

In addition, for example, in each of the storage systems, available capacities of nodes or available capacities of storage media may be monitored during the migration process, and a file may be selected from among files of a node with a small available capacity or from among files of a storage medium with a small available capacity and may be migrated based on an algorithm of the migration source distributed FS. It is therefore possible to prevent the capacity of a specific node from being excessively used due to bias to a consumed capacity of a node or storage medium.

In addition, for example, in each of the storage systems, a logical device subjected to thin provisioning to enable a file capacity for a file deleted from the migration source distributed FS to be used in the migration destination distributed FS may be shared and an instruction to collect a page upon the deletion of the file may be provided. Therefore, the page can be used.

In the following description, various information is described using the expression of “aaa tables”, but may be expressed using data structures other than tables. To indicate the independence of the information on the data structures, an “aaa table” is referred to as “aaa information” in some cases.

In the following description, an “interface (I/F)” may include one or more communication interface devices. The one or more communication interface devices maybe one or more communication interface devices (for example, one or more network interface cards (NICs)) of the same type or may be communication interface devices (for example, an NIC and a host bus adapter (HBA)) of two or more types. In addition, in the following description, configurations of tables are an example, and one table may be divided into two or more tables, and all or a portion of two or more tables may be one table.

In the following description, a “storage medium” is a physical nonvolatile storage device (for example, an auxiliary storage device), for example, a hard disk drive (HDD), a solid stage drive (SSD), a flash memory, an optical disc, a magnetic tape, or the like.

In the following description, a “memory” includes one or more memories. At least one memory may be a volatile memory or a nonvolatile memory. The memory is mainly used for a process by a processor.

In the following description, a “processor” includes one or more processors. At least one processor may be a central processing unit (CPU). The processor may include a hardware circuit that executes all or a part of a process.

In the following description, a process is described using a “program” as a subject in some cases, but the program is executed by a processor (for example, a CPU) to execute a defined process using a storage section (for example, a memory) and/or an interface (for example, a port). Therefore, a subject of description of a process may be the program. A process described using the program as a subject may be a process to be executed by a processor or a computer (for example, a node) having the processor. A controller (storage controller) may be a processor or may include a hardware circuit that executes a part or all of a process to be executed by the controller. The program may be installed in each controller from a program source. The program source may be a program distribution server or a computer-readable (for example, non-transitory) storage medium, for example. In the following description, two or more programs may be enabled as a single program, and a single program may be enabled as two or more programs.

In the following description, as identification information of an element, an ID is used, but other identification information may be used instead of or as well as the ID.

In the following description, a distributed storage system includes one or more physical computers (nodes). The one or more physical computers may include either one or both of a physical server and physical storage. At least one physical computer may execute a virtual computer (for example, a virtual machine (VM)) or software-defined anything (SDx). As the SDx, software-defined storage (SDS) (example of a virtual storage device) or a software-defined datacenter (SDDC) may be used.

In the following description, when elements of the same type are described without distinguishing between the elements, a common part (part excluding sub-numbers) of reference signs including the sub-numbers is used in some cases. In the following description, when elements of the same type are described and distinguished from each other, reference signs including sub-numbers are used in some cases. For example, when files are described without distinguishing between the files, the files are expressed by “files 613”. For example, when the files are described and distinguished from each other, the files are expressed by a “file 613-1”, a “file 613-2”, and the like.

### (1) First Embodiment

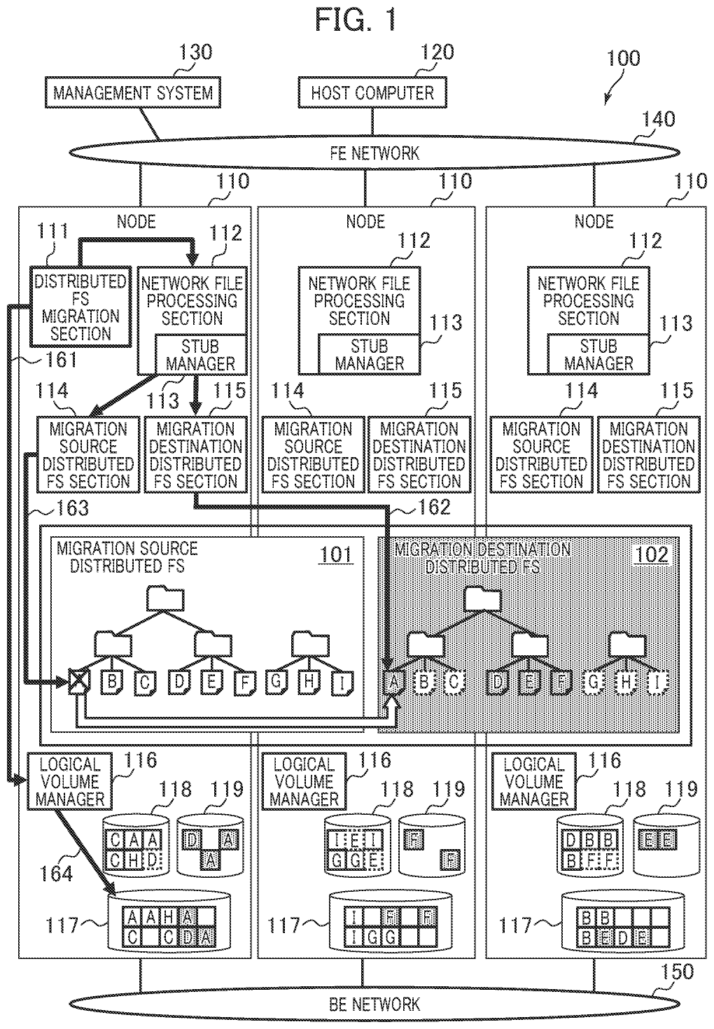

In FIG. 1, 100 indicates a storage system according to a first embodiment.

FIG. 1 is a diagram describing an overview of the storage system 100. In the storage system 100, an existing node 110 is used to migrate a file between distributed FSs of the same type or of different types.

In the storage system 100, a process of migrating a file from a migration source distributed FS 101 to a migration destination distributed FS 102 is executed on a plurality of nodes 110. The storage system 100 monitors available capacities of the nodes 110 at the time of the migration of the file and deletes the file completely migrated, thereby avoiding a failure, caused by insufficiency of an available capacity, of the migration. For example, using the same node 110 for the migration source distributed FS 101 and the migration destination distributed FS 102 enables the migration of the file between the distributed FSs without introduction of an additional node 110 for the migration.

Specifically, the storage system 100 includes one or more nodes 110, a host computer 120, and a management system 130. The nodes 110, the host computer 120, and the management system 130 are connected to and able to communicate with each other via a frontend network (FE network) 140. The nodes 110 are connected to and able to communicate with each other via a backend network (BE network) 150.

Each of the nodes 110 is, for example, a distributed FS server and includes a distributed FS migration section 111, a network file processing section 112 (having a stub manager 113), a migration source distributed FS section 114, a migration destination distributed FS section 115, and a logical volume manager 116. Each of all the nodes 110 may include a distributed FS migration section 111, or one or more of the nodes 110 may include a distributed FS migration section 111. FIG. 1 illustrates an example in which each of the nodes 110 includes a distributed FS migration section 111.

In the storage system 100, the management system 130 requests the distributed FS migration section 111 to execute migration between the distributed FSs. Upon receiving the request, the distributed FS migration section 111 stops rebalancing of the migration source distributed FS 101. Then, the distributed FS migration section 111 determines whether data is able to be migrated, based on information of a file of the migration source distributed FS 101 and available capacities of physical pools 117 of the nodes 110. In addition, the distributed FS migration section 111 acquires information of the storage destination nodes 110 and file sizes for all files of the migration source distributed FS 101. Furthermore, the distributed FS migration section 111 requests the stub manager 113 to generate a stub file. The stub manager 113 receives the request and generates, in the migration destination distributed FS 102, the same file tree as that of the migration source distributed FS 101. In the generated file tree, files are generated as stub files that enable the files of the migration source distributed FS 101 to be accessed.

Next, the distributed FS migration section 111 executes a file migration process. In the file migration process, (A) a monitoring process 161, (B) a reading and writing process (copying process) 162, (C) a deletion process 163, and (D) a release process 164, which are described below, are executed.

### (A) Monitoring Process 161

The distributed FS migration section 111 periodically makes an inquiry about available capacities of the physical pools 117 to the logical volume managers 116 of the nodes 110 and monitors the available capacities of the physical pools 117.

### (B) Reading and Writing Process 162

The distributed FS migration section 111 prioritizes and migrates a file stored in a node 110 (target node 110) including a physical pool 117 with a small available capacity. For example, the distributed FS migration section 111 requests the network file processing section 112 of the target node 110 to read the file of the migration destination distributed FS 102. The network file processing section 112 receives the request and reads the file corresponding to a stub file from the migration source distributed FS 101 via the migration source distributed FS section 114 of the target node 110 and requests the migration destination distributed FS section 115 of the target node 110 to write the file to the migration destination distributed FS section 102. The migration destination distributed FS section 115 of the target node 110 coordinates with the migration destination distributed FS section 115 of another node 110 to write the file read into the migration destination distributed FS 102.

### (C) Deletion Process 163

The distributed FS migration section 111 deletes, from the migration source distributed FS 101 via the network file processing section 112 and migration source distributed FS section 114 of the target node 110, the file completely read and written (copied) to the migration destination distributed FS 102 in the reading and writing process 162 by the distributed FS migration section 111 or in accordance with an file I/O request from the host computer 120.

### (D) Release Process 164

The distributed FS migration section 111 requests the logical volume manager 116 of the target node 110 to release a physical page allocated to a logical volume 118 (migration source FS logical VOL) for the migration source distributed FS 101 that is not used due to the deletion of the file. The logical volume manager 116 releases the physical page, thereby becoming able to allocate the physical page to a logical volume 119 (migration destination FS logical VOL) for the migration destination distributed FS 102.

When the process of migrating the file is terminated, the distributed FS migration section 111 deletes the migration source distributed FS 101 and returns a result to the management system 130.

The migration source distributed FS 101 is enabled by the coordination of the migration source distributed FS sections 114 of the nodes 110. The migration destination distributed FS 102 is enabled by the coordination of the migration destination distributed FS sections 115 of the nodes 110. Although the example in which the distributed FS migration section 111 requests the migration destination distributed FS section 115 of the target node 110 to write the file is described above, the distributed FS migration section 111 is not limited to this configuration. The distributed FS migration section 111 maybe configured to request the migration destination distributed FS section 115 of anode 110 different from the target node 110 to write the file.

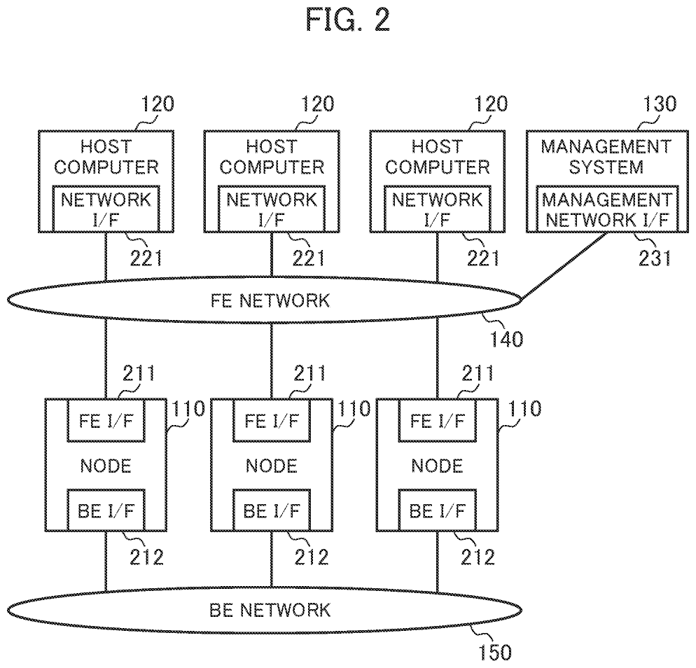

FIG. 2 is a diagram illustrating a configuration related to the storage system 100.

The storage system 100 includes one or multiple nodes 110, one or multiple host computers 120, and one or multiple management systems 130.

The node 110 provides the distributed FSs to the host computer 120 (user of the storage system 100). For example, the node 110 uses a frontend interface 211 (FE I/F) to receive a file I/O request from the host computer 120 via the frontend network 140. The node 110 uses a backend interface 212 (BE I/F) to transmit and receive data to and from the other nodes 110 (or communicate the data with the other nodes 110) via the backend network 150. The frontend interface 211 is used for the node 110 and the host computer 120 to communicate with each other via the frontend network 140. The backend interfaces 212 are used for the nodes 110 to communicate with each other via the backend network 150.

The host computer 120 is a client device of the node 110. The host computer 120 uses a network interface (network I/F) 221 to issue a file I/O request via the frontend network 140, for example.

The management system 130 is a managing device that manages the storage system 100. For example, the management system 130 uses a management network interface (management network I/F) 231 to transmit an instruction to execute migration between the distributed FSs to the node 110 (distributed FS migration section 111) via the frontend network 140.

The host computer 120 uses the network interface 221 to issue a file I/O request to the node 110 via the frontend network 140. There are some general protocols for an interface for a file I/O request to input and output a file via a network. The protocols are the Network File System (NFS), the Common Internet File System (CIFS), the Apple Filing Protocol (AFP), and the like. Each of the host computers 120 can communicate with the other host computers 120 for various purposes.

The node 110 uses the backend interface 212 to communicate with the other nodes 110 via the backend network 150. The backend network 150 is useful to migrate a file and exchange metadata or is useful for other various purposes. The backend network 150 may not be separated from the frontend network 140. The frontend network 140 and the backend network 150 may be integrated with each other.

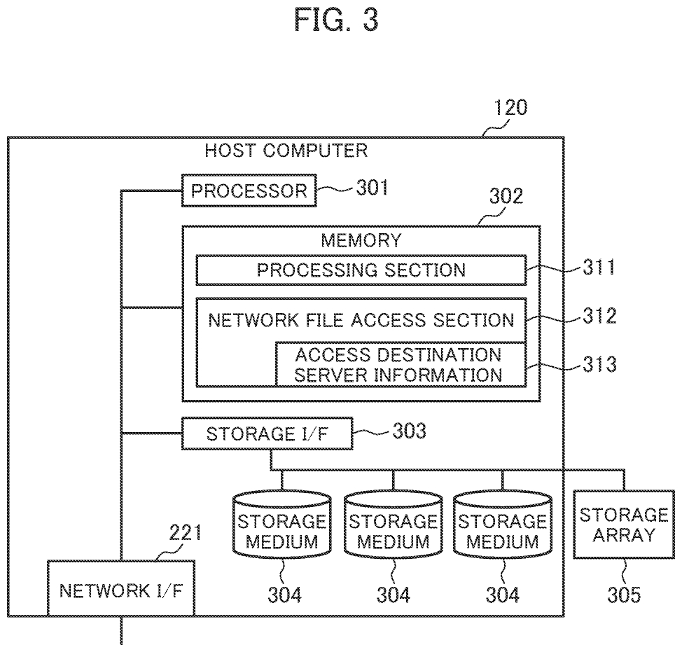

FIG. 3 is a diagram illustrating an example of a configuration related to the host computer 120.

The host computer 120 includes a processor 301, a memory 302, a storage interface (storage I/F) 303, and the network interface 221. The host computer 120 may include storage media 304. The host computer 120 may be connected to a storage array (shared storage) 305.

The host computer 120 includes a processing section 311 and a network file access section 312 as functions of the host computer 120.

The processing section 311 is a program that processes data on an external file server when the user of the storage system 100 provides an instruction to process the data. For example, the processing section 311 is a program such as a relational database management system (RDMS) or a virtual machine hypervisor.

The network file access section 312 is a program that issues a file I/O request to a node 110 and read and write data from and to the node 110. The network file access section 312 provides control on the side of the client device in accordance with a network communication protocol, but is not limited to this.

The network file access section 312 has access destination server information 313. The access destination server information 313 identifies a node 110 and a distributed FS to which a file I/O request is issued. For example, the access destination server information 313 includes one or more of a computer name of the node 110, an Internet Protocol (IP) address, a port number, and a distributed FS name.

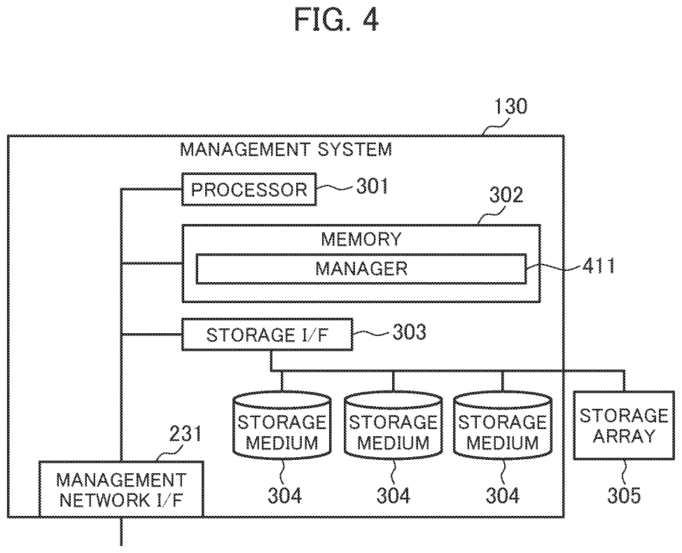

FIG. 4 is a diagram illustrating a configuration related to the management system 130.

The management system 130 basically includes a hardware configuration equivalent to the host computer 120. The management system 130, however, includes a manager 411 as a function of the management system 130 and does not include a processing section 311 and a network file access section 312. The manager 411 is a program to be used by a user to manage file migration.

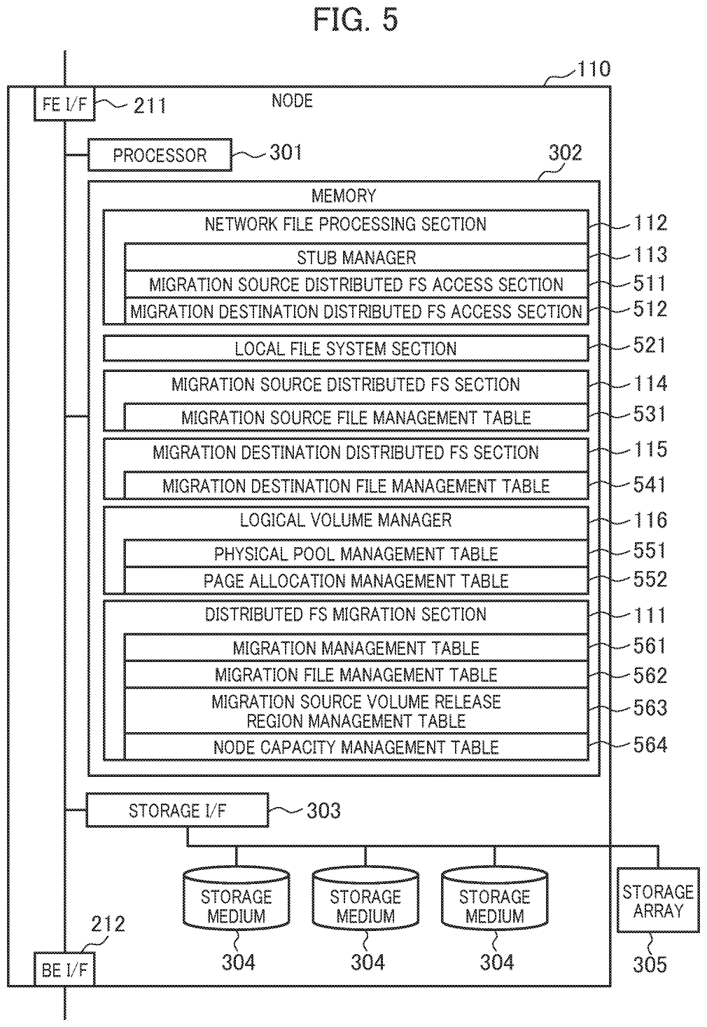

FIG. 5 is a diagram illustrating an example of a configuration related to the node 110.

The node 110 includes a processor 301, a memory 302, a storage interface 303, the frontend interface 211, the backend interface 212, and storage media 304. The node 110 may be connected to the storage array 305 instead of or as well as the storage media 304. The first embodiment describes an example in which data is basically stored in the storage media 304.

Functions (or the distributed FS migration section 111, the network file processing section 112, the stub manager 113, the migration source distributed FS section 114, the migration destination distributed FS section 115, the logical volume manager 116, a migration source distributed FS access section 511, a migration destination distributed FS access section 512, a local file system section 521, and the like) of the node 110 maybe enabled by causing the processor 301 to read a program into the memory 302 and execute the program (software), or may be enabled by hardware such as a dedicated circuit, or may be enabled by a combination of the software and the hardware. One or more of the functions of the node 110 may be enabled by another computer that is able to communicate with the node 110.

The processor 301 controls a device within the node 110.

The processor 301 causes the network file processing section 112 to receive a file I/O request from the host computer 120 via the frontend interface 211 and returns a result. When access to data stored in the migration source distributed FS 101 or the migration destination distributed FS 102 needs to be made, the network file processing section 112 issues a request (file I/O request) to access the data to the migration source distributed FS section 114 or the migration destination distributed FS section 115 via the migration source distributed FS access section 511 or the migration destination distributed FS access section 512.

The processor 301 causes the migration source distributed FS section 114 or the migration destination distributed FS section 115 to process the file I/O request, reference a migration source file management table 531 or a migration destination file management table 541, and read and write data from and to a storage medium 304 connected via the storage interface 303 or request another node 110 to read and write data via the backend interface 212.

As an example of the migration source distributed FS section 114 or the migration destination distributed FS section 115, GlusterFS, CephFS, or the like is used. The migration source distributed FS section 114 and the migration destination distributed FS section 115, however, are not limited to this.

The processor 301 causes the stub manager 113 to manage a stub file and acquire a file corresponding to the stub file. The stub file is a virtual file that does not have data of the file and indicates a location of the file stored in the migration source distributed FS 101. The stub file may have a portion of or all the data as a cache. Each of UP Patent No. 7330950 and UP Patent No. 8856073 discloses a method for managing layered storage in units of files based on a stub file and describes an example of the structure of the stub file.

The processor 301 causes the logical volume manager 116 to reference a page allocation management table 552, allocate a physical page to the logical volume 118 or 119 used by the migration source distributed FS section 114 or the migration destination distributed FS section 115, and release the allocated physical page.

The logical volume manager 116 provides the logical volumes 118 and 119 to the migration source distributed FS section 114 and the migration destination distributed FS section 115. The logical volume manager 116 divides a physical storage region of one or more storage media 304 into physical pages of a fixed length (of, for example, 42 MB) and manages, as a physical pool 117, all the physical pages within the node 110. The logical volume manager 116 manages regions of the logical volumes 118 and 119 as a set of logical pages of the same size as each of the physical pages. When initial writing is executed on a logical page, the logical volume manager 116 allocates a physical page to the logical page. Therefore, a capacity efficiency can be improved by allocating a physical page to only a logical page actually used (so-called thin provisioning function).

The processor 301 uses the distributed FS migration section 111 to copy a file from the migration source distributed FS 101 to the migration destination distributed FS 102 and delete the completely copied file from the migration source distributed FS 101.

An interface such as Fiber Channel (FC), Serial Attached Technology Attachment (SATA), Serial Attached SCSI (SAS), or Integrated Device Electronics (IDE) is used for communication between the processor 301 and the storage interface 303. The node 110 may include storage media 304 of many types, such as an HDD, an SSD, a flash memory, an optical disc, and a magnetic tape.

The local file system section 521 is a program for controlling a file system to be used to manage files distributed by the migration source distributed FS 101 or the migration destination distributed FS 102 to the node 110. The local file system section 521 builds the file system on the logical volumes 118 and 119 provided by the logical volume manager 116 and can access an executed program in units of files.

For example, XFS or EXT4 is used for GlusterFS. In the first embodiment, the migration source distributed FS 101 and the migration destination distributed FS 102 may cause the same file system to manage data within the one or more nodes 110 or may cause different file systems to manage the data within the one or more nodes 110. In addition, like CephFS, a local file system may not be provided, and a file may be stored as an object.

The memory 302 stores various information (or the migration source file management table 531, the migration destination file management table 541, a physical pool management table 551, the page allocation management table 552, a migration management table 561, a migration file management table 562, a migration source volume release region management table 563, a node capacity management table 564, and the like). The various information may be stored in the storage media 304 and read into the memory 302.

The migration source management table 531 is used to manage a storage destination (actual position or location) of data of a file in the migration source distributed FS 101. The migration destination file management table 541 is used to manage a storage destination of data of a file in the migration destination distributed FS 102. The physical pool management table 551 is used to manage an available capacity of the physical pool 117 in the node 110. The page allocation management table 552 is used to manage the allocation of physical pages with physical capacities provided from the storage media 304 to the logical volumes 118 and 119.

The migration management table 561 is used to manage migration states of the distributed FSs. The migration file management table 562 is used to manage a file to be migrated from the migration source distributed FS 101 to the migration destination distributed FS 102. The migration source volume release region management table 563 is used to manage regions from which files have been deleted and released and that are within the logical volume 118 used by the migration source distributed FS 101. The node capacity management table 564 is used to manage available capacities of the physical pools 117 of the nodes 110.

In the first embodiment, the network file processing section 112 includes the stub manager 113, the migration source distributed FS access section 511, and the migration destination distributed FS access section 512. Another program may include the stub manager 113, the migration source distributed FS access section 511, and the migration destination distributed FS access section 512. For example, an application of a relational database management system (RDBMS), an application of a web server, an application of a video distribution server, or the like may include the stub manager 113, the migration source distributed FS access section 511, and the migration destination distributed FS access section 512.

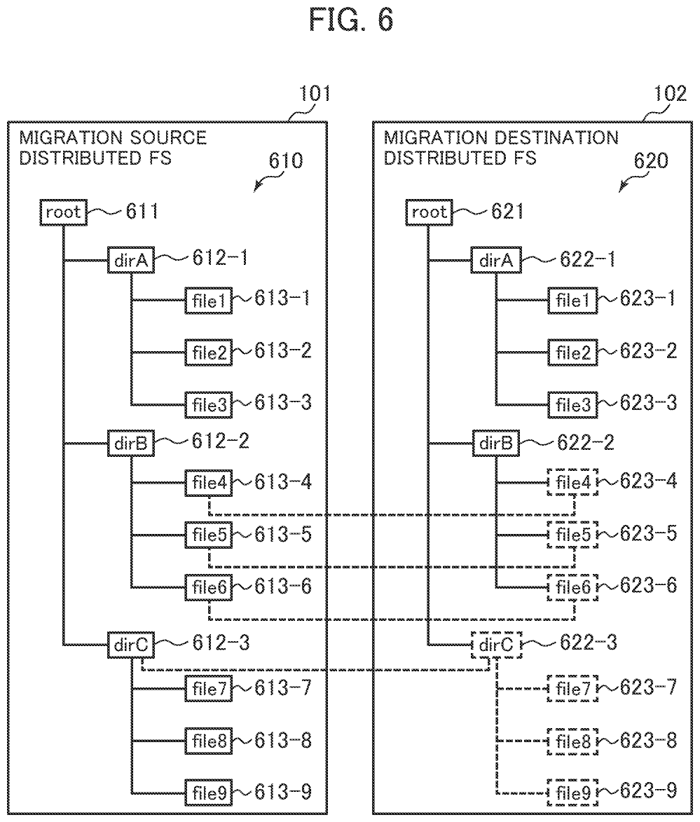

FIG. 6 is a diagram illustrating an implementation example of the distributed FSs that use a stub file.

A file tree 610 of the migration source distributed FS 101 indicates file hierarchy of the migration source distributed FS 101 that is provided by the node 110 to the host computer 120. The file tree 610 includes a root 611 and directories 612. Each of the directories 612 includes files 613. Locations of the files 613 are indicated by path names obtained by using slashes to connect directory names of the directories 612 to file names of the files 613. For example, a path name of a file 613-1 is “/root/dirA/file1”.

A file tree 620 of the migration destination distributed FS 102 indicates file hierarchy of the migration destination distributed FS 102 that is provided by the node 110 to the host computer 120. The file tree 620 includes a root 621 and directories 622. Each of the directories 622 includes files 623. Locations of the files 623 are indicated by path names obtained by using slashes to connect directory names of the directories 622 to file names of the files 623. For example, a path name of a file 623-1 is “/root/dirA/file1”.

In the foregoing example, the file tree 610 of the migration source distributed FS 101 and the file tree 620 of the migration destination distributed FS 102 have the same tree structure. The file trees 610 and 620, however, may have different tree structures.

The distributed FSs that use the stub file can be used as normal distributed FSs. For example, since files 623-1, 623-2, and 623-3 are normal files, the host computer 120 can specify path names “/root/dirA/file1”, “/root/dirA/file2”, “/root/dirA/”, and the like and execute reading and writing.

For example, files 623-4, 623-5, and 623-6 are an example of stub files managed by the stub manager 113. The migration destination distributed FS 102 causes a portion of data of the files 623-4, 623-5, and 623-6 to be stored in a storage medium 304 included in the node 110 and determined by a distribution algorithm.

The files 623-4, 623-5, and 623-6 store only metadata such as file names and file sizes and do not store data other than the metadata. The files 623-4, 623-5, and 623-6 store information on locations of data, instead of holding the entire data.

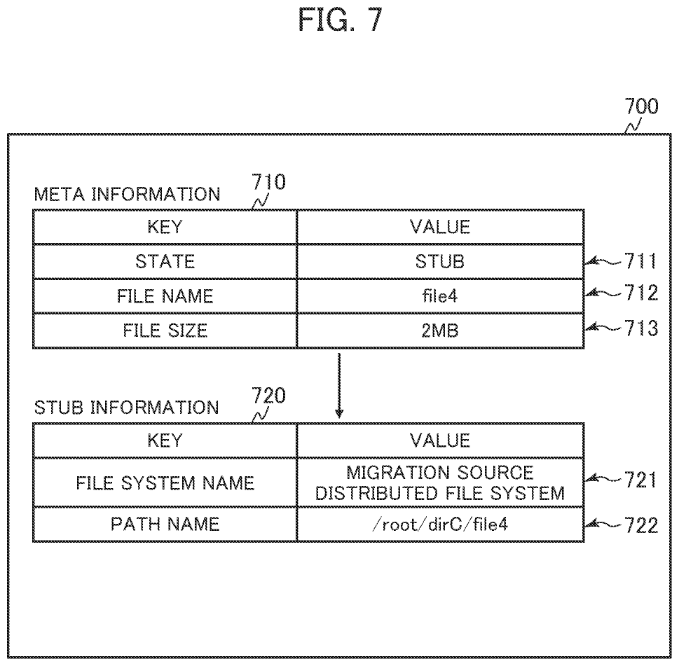

The stub files are managed by the stub manager 113. FIG. 7 illustrates a configuration of a stub file. As illustrated in FIG. 7, the stub manager 113 adds stub information 720 to meta information 710, thereby realizing the stub file. The stub manager 113 realizes control related to the stub file based on the configuration of the stub file.

A directory 622-3 “/root/dirC” can be used as a stub file. In this case, the stub manager 113 may not have information on files 623-7, 623-8, and 623-9 belonging to the directory 622-3. When the host computer 120 accesses a file belonging to the directory 622-3, the stub manager 113 generates stub files for the files 623-7, 623-8, and 623-9.

FIG. 7 is a diagram illustrating an example (stub file 700) of the configuration of the stub file.

The meta information 710 stores metadata of a file 623. The meta information 710 includes information (entry 711) indicating whether the file 623 is a stub file (or whether the file 623 is a normal file or the stub file).

When the file 623 is the stub file, the meta information 710 is associated with the corresponding stub information 720. For example, when the file 623 is the stub file, the file includes the stub information 720. When the file 623 is not the stub file, the file does not include the stub information 720. The meta information 710 needs to be sufficient for a user of the file systems.

When the file 623 is the stub file, information necessary to specify a path name and a state indicating whether the file 623 is the stub file is an entry 711 and information (entry 712) indicating the file name. Information (entry 713) that indicates other information of the stub file and is a file size of the stub file and the like is acquired by causing the migration destination distributed FS section 115 to reference the corresponding stub information 720 and the migration source distributed FS 101.

The stub information 720 indicates a storage destination (actual position) of data of the file 623. In the example illustrated in FIG. 7, the stub information 720 includes information (entry 721) indicating a migration source distributed FS name of the migration source distributed FS 101 and information (entry 722) indicating a path name of a path on the migration source distributed FS 101. By specifying the path name of the path on the migration source distributed FS 101, a location of the data of the file is identified. The actual file 623 does not need to have the same path name as that of the migration destination distributed FS 102.

The stub manager 113 can convert a stub file into a file in response to “recall”. The “recall” is a process of reading data of an actual file from the migration source distributed FS 101 identified by the stub information 720 via the backend network 150. After all the data of the file is copied, the stub manager 113 deletes the stub information 720 from the stub file 700 and sets a state of the meta information 710 to “normal”, thereby setting the file 623 from the stub file to a normal file.

An example of a storage destination of the stub information 720 is extended attributes of CephFS, but the storage destination of the stub information 720 is not limited to this.

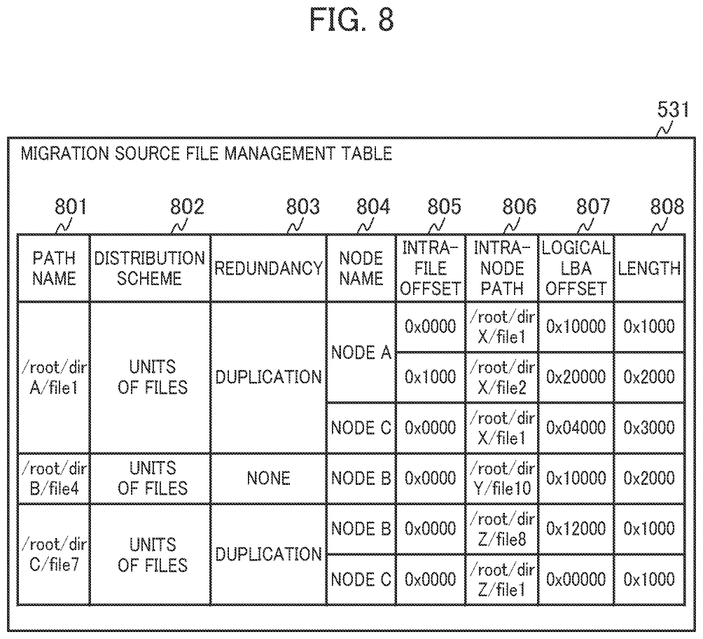

FIG. 8 is a diagram illustrating an example of a data structure of the migration source file management table 531. The migration destination file management table 541 may have an arbitrary data structure and will not be described in detail below.

The migration source file management table 531 includes information (entries) composed of a path name 801, a distribution scheme 802, redundancy 803, a node name 804, an intra-file offset 805, an intra-node path 806, a logical LBA offset 807, and a length 808. LBA is an abbreviation for Logical Block Addressing.

The path name 801 is a field for storing names (path names) indicating locations of files in the migration source distributed FS 101. The distribution scheme 802 is a field indicating distribution schemes (representing units in which the files are distributed) of the migration source distributed FS 101. As an example, although data distribution is executed based on distributed hash tables (DHTs) of GlusterFS, Erasure Coding, or CephFS, the distribution schemes are not limited to this. The redundancy 803 is a field indicating how the files are made redundant in the migration source distributed FS 101. As the redundancy 803, duplication, triplication, and the like may be indicated.

The node name 804 is a field for storing node names of nodes 110 storing data of the files. One or more node names 804 are provided for each of the files.

The intra-file offset 805 is a field for storing an intra-file offset for each of data chunks into which data is divided in the files and that are stored. The intra-node path 806 is a field for storing paths in the nodes 110 associated with the intra-file offset 805. The intra-node path 806 is a field for storing paths in the nodes 110 associated with the intra-file offset 805. The intra-node path 806 may indicate identifiers of data associated with the intra-file offset 805. The logical LBA offset 807 is a field for storing offsets of LBAs (logical LBAs) of logical volumes 118 storing data associated with the intra-node path 806. The length 808 is a field for storing the numbers of logical LBAs used for the paths indicated by the intra-node path 806 on the migration source distributed FS 101.

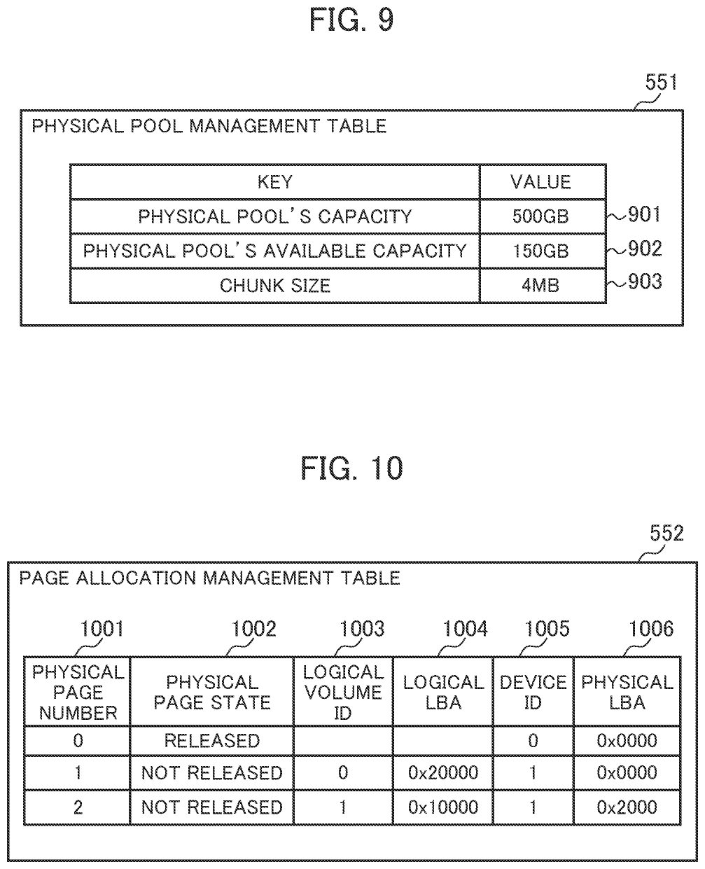

FIG. 9 is a diagram illustrating an example of a data structure of the physical pool management table 551.

The physical pool management table 551 includes information (entries) composed of a physical pool's capacity 901, a physical pool's available capacity 902, and a chunk size 903.

The physical pool's capacity 901 is a field indicating a physical capacity provided from a storage medium 304 within the node 110. The physical pool's available capacity 902 is a field indicating the total capacity, included in the physical capacity indicated by the physical pool's capacity 901, of physical pages not allocated to the logical volumes 118 and 119. The chunk size 903 is a field indicating sizes of physical pages allocated to the logical volumes 118 and 119.

FIG. 10 is a diagram illustrating an example of a data structure of the page allocation management table 552.

The page allocation management table 552 includes information (entries) composed of a physical page number 1001, a physical page state 1002, a logical volume ID 1003, a logical LBA 1004, a device ID 1005, and a physical LBA 1006.

The physical page number 1001 is a field for storing page numbers of physical pages in the physical pool 117. The physical page state 1002 is a field indicating whether the physical pages are already allocated.

The logical volume ID 1003 is a field for storing logical volume IDs of the logical volumes 118 and 119 that are allocation destinations associated with the physical page number 1001 when physical pages are already allocated. The logical volume ID 1003 is empty when a physical page is not allocated. The logical LBA 1004 is a field for storing logical LBAs of the allocation destinations associated with the physical page number 1001 when the physical pages are already allocated. The logical LBA 1004 is empty when a physical page is not allocated.

The device ID 1005 is a field for storing device IDs identifying storage media having the physical pages of the physical page number 1001. The physical LBA 1006 is a field for storing LBAs (physical LBAs) associated with the physical pages of the physical page number 1001.

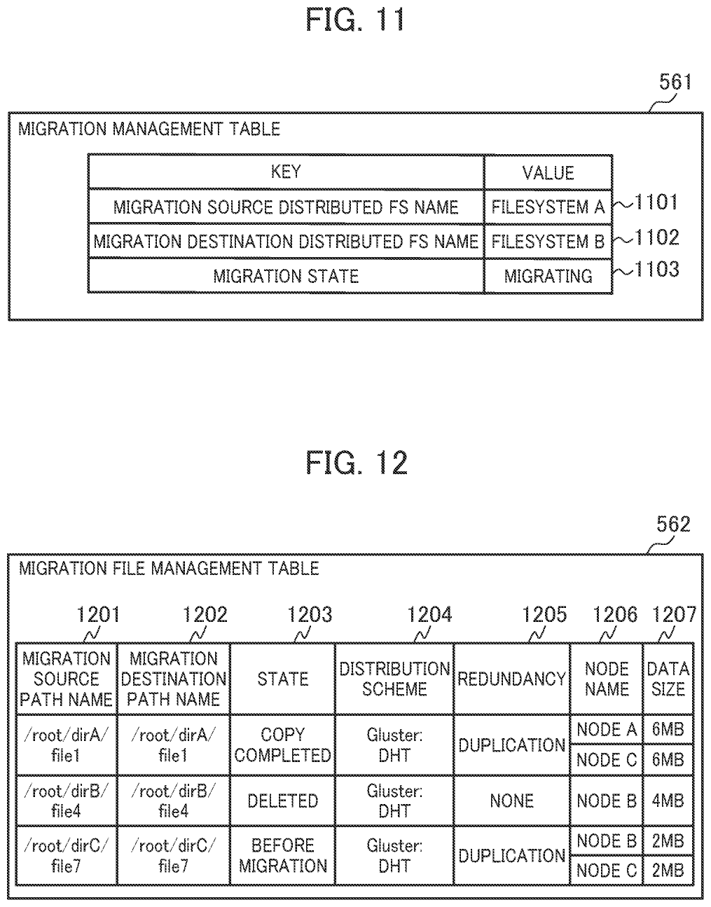

FIG. 11 is a diagram illustrating an example of a data structure of the migration management table 561.

The migration management table 561 includes information (entries) composed of a migration source distributed FS name 1101, a migration destination distributed FS name 1102, and a migration state 1103.

The migration source distributed FS name 1101 is a field for storing a migration source distributed FS name of the migration source distributed FS 101. The migration destination distributed FS name 1102 is a field for storing a migration destination distributed FS name of the migration destination distributed FS 102. The migration state 1103 is a field indicating migration states of the distributed FSs. As the migration state 1103, three states that represent “before migration”, “migrating”, and “migration completed” may be indicated.

FIG. 12 is a diagram illustrating an example of a data structure of the migration file management table 562.

The migration file management table 562 includes information (entries) composed of a migration source path name 1201, a migration destination path name 1202, a state 1203, a distribution scheme 1204, redundancy 1205, a node name 1206, and a data size 1207.

The migration source path name 1201 is a field for storing the path names of the files in the migration source distributed FS 101. The migration destination path name 1202 is a field for storing path names of files in the migration destination distributed FS 102. The state 1203 is a field for storing states of the files associated with the migration source path name 1201 and the migration destination distributed path name 1202. As the state 1203, three states that represent “before migration”, “deleted”, and “copy completed” may be indicated.

The distribution scheme 1204 is a field indicating distribution schemes (representing units in which the files are distributed) of the migration source distributed FS 101. As an example, although data distribution is executed based on distributed hash tables (DHTs) of GlusterFS, Erasure Coding, or CephFS, the distribution schemes are not limited to this. The redundancy 1205 is a field indicating how the files are made redundant in the migration source distributed FS 101.

The node name 1206 is a field for storing node names of nodes 110 storing data of the files to be migrated. One or more node names are indicated by the node name 1206 for each of the files. The data size 1207 is a field for storing data sizes of the files stored in the nodes 110 and to be migrated.

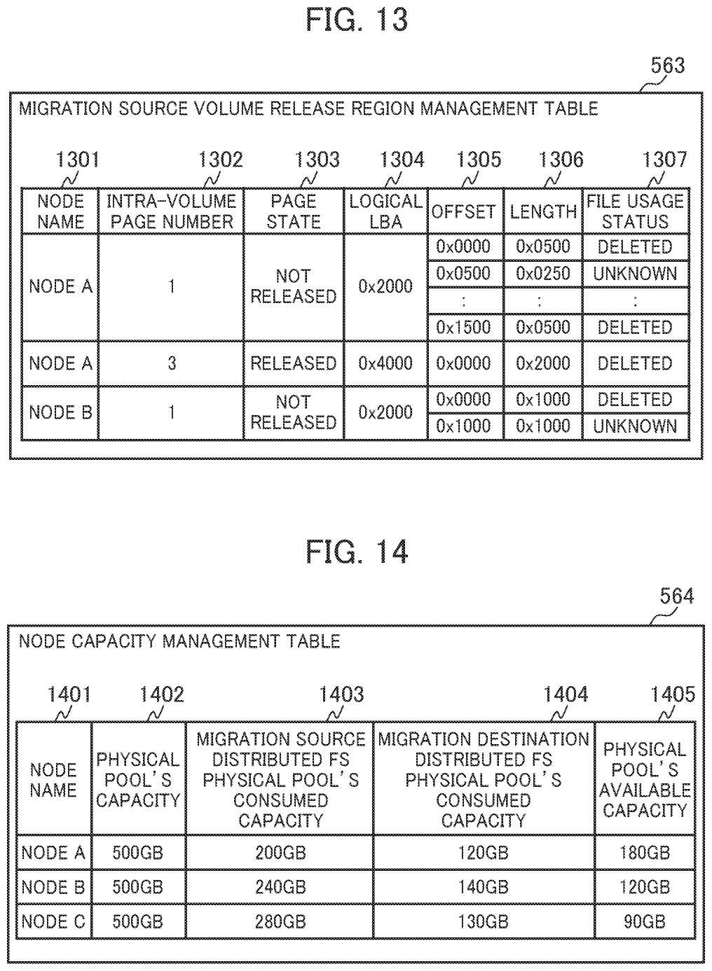

FIG. 13 is a diagram illustrating an example of a data structure of the migration source volume release region management table 563. [0112]

The migration source volume release region management table 563 includes information (entries) composed of a node name 1301, an intra-volume page number 1302, a page state 1303, a logical LBA 1304, an offset 1305, a length 1306, and a file usage status 1307.

The node name 1301 is a field for storing node names of nodes 110 constituting the migration source distributed FS 101. The intra-volume page number 1302 is a field for storing physical page numbers of physical pages allocated to logical volumes 118 used by the migration source distributed FS 101 in the nodes 110 associated with the node name 1301. The page state 1303 is a field indicating whether the physical pages associated with the intra-volume page number 1302 are already released. The logical LBA 1304 is a field for storing LBAs, associated with the physical pages of the intra-volume page number 1302, of the logical volumes 118 used by the migration source distributed FS 101.

The offset 1305 is a field for storing offsets within the physical pages associated with the intra-volume page number 1302. The length 1306 is a field for storing lengths from the offsets 1305. The file usage status 1307 is a field indicating usage statuses related to regions for the lengths 1306 from the offsets indicated by the offset 1305. As the file usage status 1307, two statuses that represent “deleted” and “unknown” may be indicated.

FIG. 14 is a diagram illustrating an example of a data structure of the node capacity management table 564.

The node capacity management table 564 includes information (entries) composed of a node name 1401, a physical pool's capacity 1402, a migration source distributed FS physical pool's consumed capacity 1403, a migration destination distributed FS physical pool's consumed capacity 1404, and a physical pool's available capacity 1405.

The node name 1401 is a field for storing the node names of the nodes 110. The physical pool's capacity 1402 is a field for storing capacities of the physical pools 117 of the nodes 110 associated with the node name 1401. The migration source distributed FS physical pool's consumed capacity 1403 is a field for storing capacities of the physical pools 117 that are consumed by the migration source distributed FS 101 in the nodes 110 associated with the node name 1401. The migration destination distributed FS physical pool's consumed capacity 1404 is a field for storing capacities of the physical pools 117 that are consumed by the migration destination distributed FS 102 in the nodes 110 associated with the node name 1401. The physical pool's available capacity 1405 is a field for storing available capacities of the physical pools 117 of the nodes 110 associated with the node name 1401.

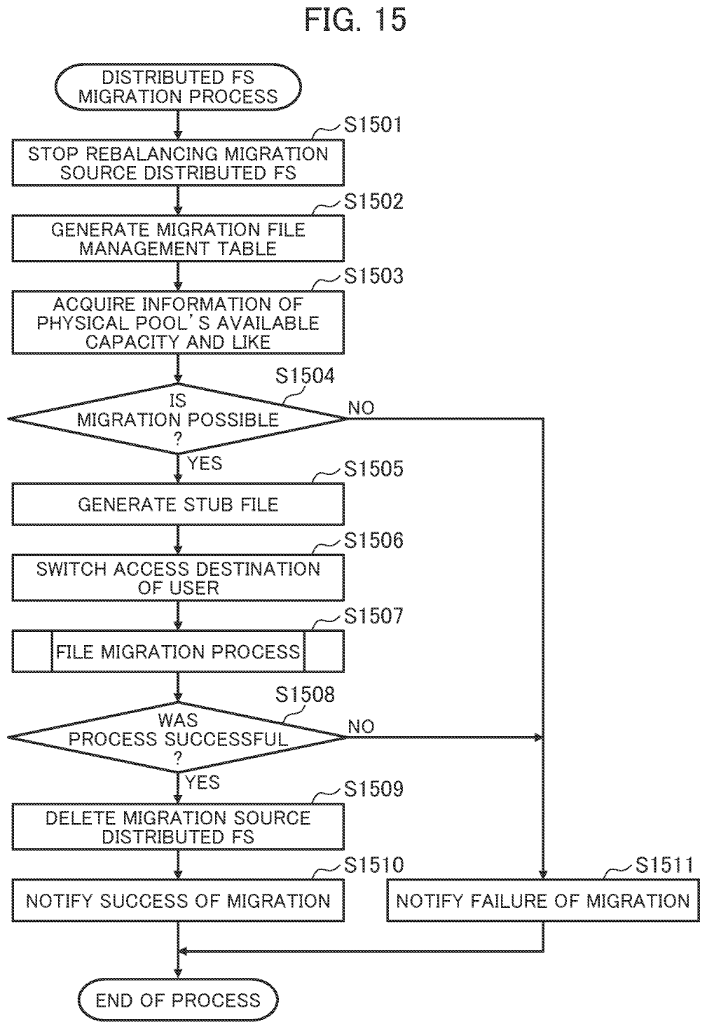

FIG. 15 is a diagram illustrating an example of a flowchart related to a distributed FS migration process. The distributed FS migration section 111 starts the distributed FS migration process upon receiving, from a user via the management system 130, an instruction to execute migration between the distributed FSs.

The distributed FS migration section 111 requests the migration source distributed FS section 114 to stop the rebalancing (in step S1501). The request to stop the rebalancing is provided to prevent performance from decreasing when the distributed FS migration section 111 deletes a file from the migration source distributed FS 101 in response to the migration of the file and the migration source distributed FS 101 executes the rebalancing.

The distributed FS migration section 111 acquires information of the migration source path name 1201, the distribution scheme 1204, the redundancy 1205, the node name 1206, and the data size 1207 for all files from the migration source file management table 531 included in the migration source distributed FS section 114 and generates the migration file management table 562 (in step S1502).

The distributed FS migration section 111 makes an inquiry to the logical volume managers 116 of the nodes 110, acquires information of the capacities of the physical pools 117 and available capacities of the physical pools 117, causes the acquired information to be stored as information of the node name 1401, the physical pool's capacity 1402, and the physical pool's available capacity 1405 in the node capacity management table 564 (in step S1503).

The distributed FS migration section 111 determines whether migration is possible based on the physical pool's available capacity 1405 (in step S1504). For example, when an available capacity of the physical pool 117 of the node 110 is 5% or less, the distributed FS migration section 111 determines that the migration is not possible. It is assumed that this threshold is given by the management system 130. When the distributed FS migration section 111 determines that the migration is possible, the distributed FS migration section 111 causes the process to proceed to step S1505. When the distributed FS migration section 111 determines that the migration is not possible, the distributed FS migration section 111 causes the process to proceed to step S1511.

In step S1505, the distributed FS migration section 111 causes the stub manager 113 to generate a stub file. The stub manager 113 generates the same file tree as the migration source distributed FS 101 on the migration destination distributed FS 102. In this case, all the files are stub files and do not have data.

Subsequently, the host computer 120 changes the access destination server information 313 in accordance with an instruction from the user via the management system 130, thereby switching a transmission destination of file I/O requests from the existing migration source distributed FS 101 to the new migration destination distributed FS 102 (in step S1506). After that, all the file I/O requests are transmitted to the new migration destination distributed FS 102 from the host computer 120.

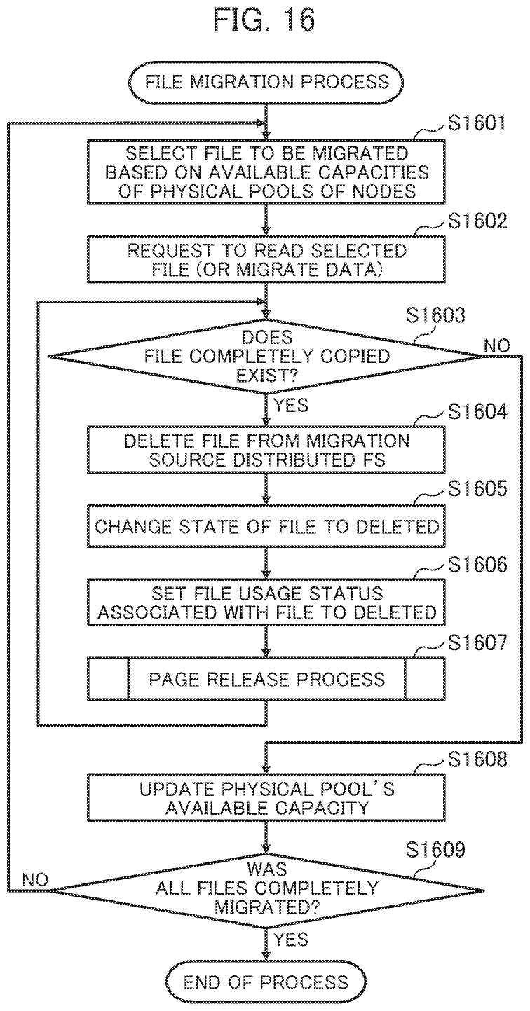

The distributed FS migration section 111 migrates all the files (file migration process (in step S1507). The file migration process is described later in detail with reference to FIG. 16.

The distributed FS migration section 111 determines whether the file migration process was successful (in step S1508). When the distributed FS migration section 111 determines that the file migration process was successful, the distributed FS migration section 111 causes the process to proceed to step S1509. When the distributed FS migration section 111 determines that the file migration process was not successful, the distributed FS migration section 111 causes the process to proceed to step S1511.

In step S1509, the distributed FS migration section 111 deletes the migration source distributed FS 101.

Subsequently, the distributed FS migration section 111 notifies the management system 130 that the migration was successful (in step S1510). Then, the distributed FS migration section 111 terminates the distributed FS migration process.

In step S1511, the distributed FS migration section 111 notifies the management system 130 that the migration failed (in step S1511). Then, the distributed FS migration section 111 terminates the distributed FS migration process.

FIG. 16 is a diagram illustrating an example of a flowchart related to the file migration process.

The distributed FS migration section 111 selects a file to be migrated, based on available capacities of the physical pools 117 of the nodes 110 (in step S1601). Specifically, the distributed FS migration section 111 confirms the physical pool's available capacity 1405 for each of the nodes 110 from the node capacity management table 564, identifies a node 110 having a physical pool 117 with a small available capacity, and acquires a path name, indicated by the migration destination path name 1202, of a file having data in the identified node 110 from the migration file management table 562.

In this case, the distributed FS migration section 111 may use a certain algorithm to select the file among a group of files having data in the identified node 110. For example, the distributed FS migration section 111 selects a file of the smallest data size indicated by the data size 1207. When the smallest available capacity among available capacities of the physical pools 117 is larger than the threshold set by the management system 130, the distributed FS managing section 111 may select a plurality of files (all files having a fixed length and belonging to a directory) and request the migration destination distributed FS 102 to migrate the plurality of files in step S1602.

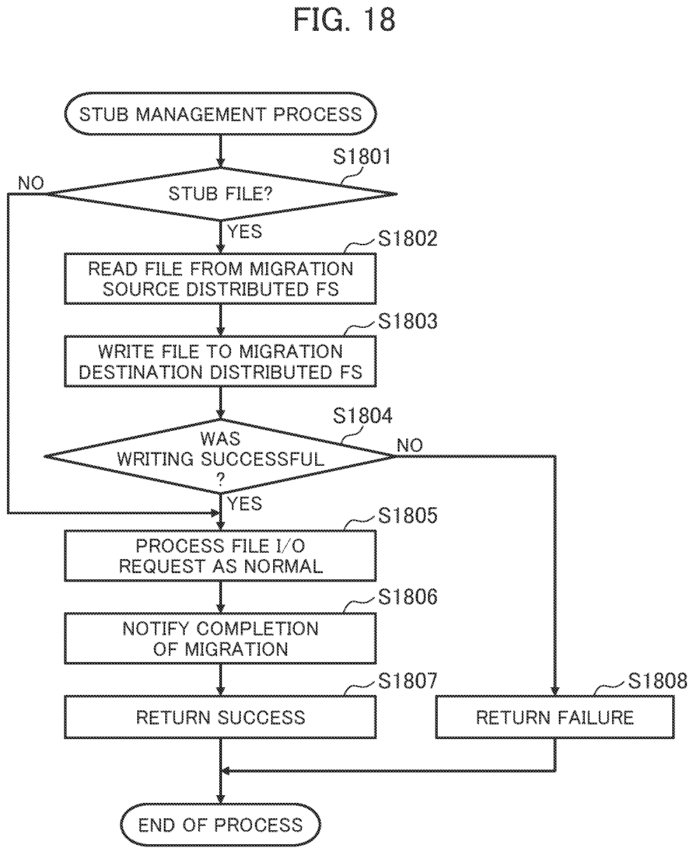

The distributed FS migration section 111 requests the network file processing section 112 to read the file selected in step S1601 and present on the migration destination distributed FS 102 (or transmits a file I/O request) (in step S1602). The selected file is copied by the stub manager 113 of the network file processing section 112 in the same manner as data copying executed with file reading, and the copying of the file is completed. The data copying executed with the file reading is described later in detail with reference to FIG. 18.

The distributed FS migration section 111 receives a result from the migration destination distributed FS 102, references the migration file management table 562, and determines whether an entry indicating “copy completed” in the state 1203 exists (or whether a file completely copied exists) (in step S1603). When the distributed FS migration section 111 determines that the file completely copied exists, the distributed FS migration section 111 causes the process to proceed to step S1604. When the distributed FS migration section 111 determines that the file completely copied does not exist, the distributed FS migration section 111 causes the process to proceed to step S1608.

In step S1604, the distributed FS migration section 111 requests the migration source distributed FS 101 to delete a file having a path name indicated by the migration source path name 1201 and included in the foregoing entry via the network file processing section 112. The distributed FS migration section 111 may acquire a plurality of files in step S1603 and request the migration source distributed FS 101 to delete a plurality of files.

Subsequently, the distributed FS migration section 111 changes a state included in the foregoing entry and indicated by the state 1203 to “deleted” (in step S1605).

Subsequently, the distributed FS migration section 111 sets, to “deleted”, a status associated with the deleted file and indicated by the file usage status 1307 of the migration source volume release region management table 563 (in step S1606). Specifically, the distributed FS migration section 111 acquires, from the migration source distributed FS 101, a utilized block (or an offset and length of a logical LBA) of the deleted file and sets, to “deleted”, the status indicated by the file usage status 1307 of the migration source volume release region management table 563. For example, for GlusterFS, the foregoing information can be acquired by issuing an XFS_BMAP command to XFS internally used. The acquisition, however, is not limited to this method, and another method may be used.

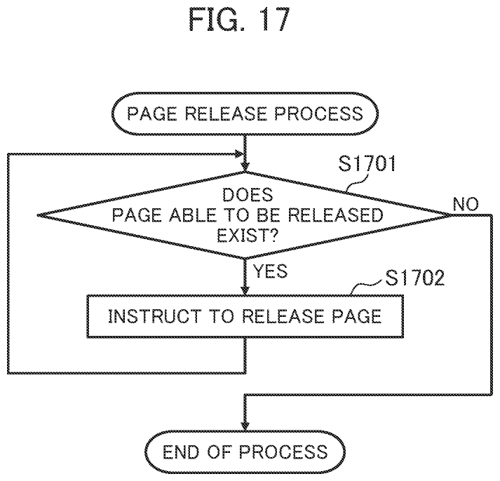

Subsequently, the distributed FS migration section 111 executes a page release process (in step S1607). In the page release process, the distributed FS migration section 111 references the migration source volume release region management table 563 and releases a releasable physical page. The page release process is described later in detail with reference to FIG. 17.

In step S1608, the distributed FS migration section 111 requests each of the logical volume managers 116 of the nodes 110 to provide the physical pool's available capacity 902 and updates the physical pool's available capacity 1405 of the node capacity management table 564.

Subsequently, the distributed FS migration section 111 references the migration source volume release region management table 563 and determines whether all entries indicate “deleted” in the state 1203 (or whether the migration of all files has been completed). When the distributed FS migration section 111 determines that the migration of all the files has been completed, the distributed FS migration section 111 terminates the file migration process. When the distributed FS migration section 111 determines that the migration of all the files has not been completed, the distributed FS migration section 111 causes the process to return to step S1601.

FIG. 17 is a diagram illustrating an example of a flowchart related to the page release process.

The distributed FS migration section 111 references the migration source volume release region management table 563 and determines whether an entry that indicates “deleted” in all cells of the entry in the file usage status 1307 exists (or whether a releasable physical page exists) (in step S1701). When the distributed FS migration section 111 determines that the releasable physical page exists, the distributed FS migration section 111 causes the process to proceed to step S1702. When the distributed FS migration section 111 determines that the releasable physical page does not exist, the distributed FS migration section 111 terminates the page release process.

In step S1702, the distributed FS migration section 111 instructs a logical volume manager 116 of a node 110 indicated by the node name 1301 in the entry indicating “deleted” in all the cells of the entry in the file usage status 1307 to release the physical page of the intra-volume page number 1302, sets the physical page associated with the page state 1303 to “released”, and terminates the page release process.

FIG. 18 is a diagram illustrating an example of a flowchart related to a stub management process to be executed when the network file processing section 112 receives a file I/O request.

The stub manager 113 references the state of the meta information 710 and determines whether a file to be processed is a stub file (in step S1801). When the stub manager 113 determines that the file to be processed is the stub file, the stub manager 113 causes the process to proceed to step S1802. When the stub manager 113 determines that the file to be processed is not the stub file, the stub manager 113 causes the process to proceed to step S1805.

In step S1802, the migration source distributed FS access section 511 reads data of the file to be processed from the migration source distributed FS 101 via the migration source distributed FS section 114. When the host computer 120 provides a request to overwrite the file, the reading of the data of the file is not necessary.

Subsequently, the migration destination distributed FS access section 512 writes the data of the read file to the migration destination distributed FS 102 via the migration destination distributed FS section 115 (in step S1803).

Subsequently, the stub manager 113 determines whether the writing (copying of the file) was successful (in step S1804). When the stub manager 113 determines that all the data within the file has been copied and written or that the data of the file does not need to be acquired from the migration source distributed FS 101, the stub manager 113 converts the stub file into a file and causes the process to proceed to step S1805. When the stub manager 113 determines that the writing was not successful, the stub manager 113 causes the process to proceed to step S1808.

In step S1805, the migration destination distributed FS access section 512 processes the file I/O request via the migration destination distributed FS section 115 as normal.

Subsequently, the stub manager 113 notifies the completion of the migration to the distributed FS migration section 111 (in step S1806). Specifically, the stub manager 113 changes, to “copy completed”, a state indicated by the state 1203 in an entry included in the migration file management table 562 and corresponding to a file of which all data has been read or written or does not need to be acquired from the migration source distributed FS 101. Then, the stub manager 113 notifies the completion of the migration to the distributed FS migration section 111. When the stub manager 113 is requested by the host computer 120 to migrate a directory or a file, the stub manager 113 reflects the migration in the migration destination path name 1202 of the migration file management table 562.

Subsequently, the stub manager 113 returns the success to the host computer 120 or the distributed FS migration section 111 (in step S1807) and terminates the stub management process.

In step S1808, the stub manager 113 returns the failure to the host computer 120 or the distributed FS migration section 111 and terminates the stub management process.

In the first embodiment, the capacities are shared between the migration source distributed FS 101 and the migration destination distributed FS 102 using the physical pools 117 subjected to the thin provisioning, but the invention is applicable to other capacity sharing (for example, the storage array 305).

In the first embodiment, the data migration is executed between the distributed FSs, but is applicable to object storage by managing objects as files. In addition, the data migration is applicable to block storage by dividing the volumes into sections of a fixed length and managing the sections as files. In addition, the data migration is applicable to migration between local file systems within the same node 110.

According to the first embodiment, the migration can be executed between systems of different types without separately preparing a migration destination node and is applicable to the latest software.

### (2) Second Embodiment

In a second embodiment, data stored in the nodes 110 by the migration source distributed FS 101 and the migration destination distributed FS 102 is managed by a common local file system section 521. By using a configuration described in the second embodiment, the invention is applicable to a configuration in which a logical volume manager 116 for a system targeted for migration does not provide a thin provisioning function.

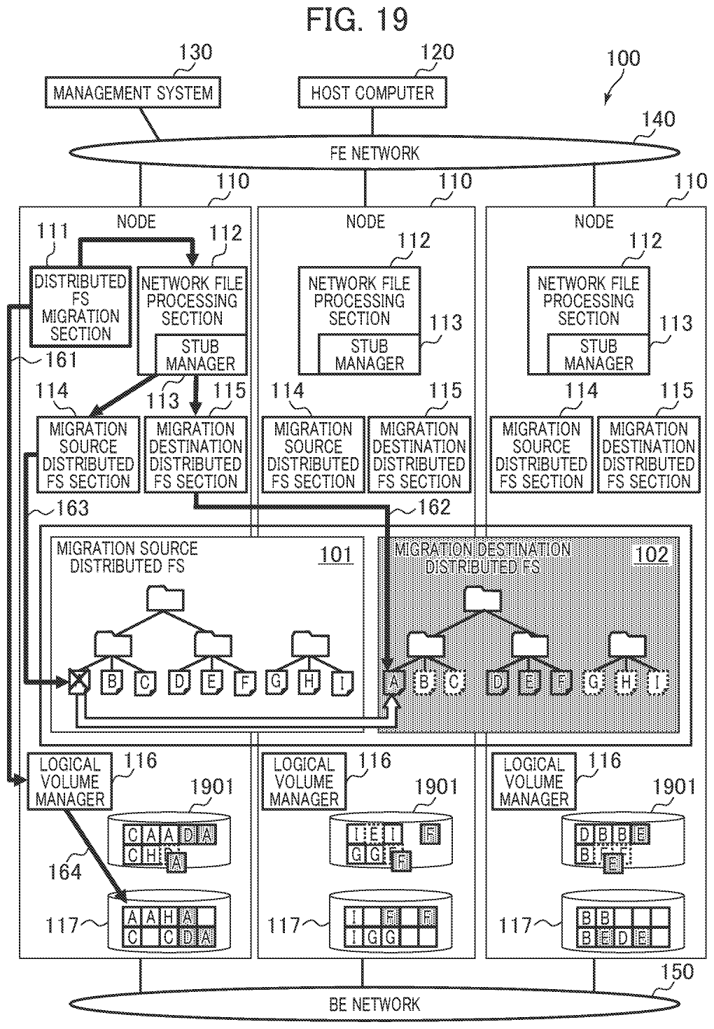

FIG. 19 is a diagram describing an overview of a storage system 100 according to the second embodiment. The second embodiment describes a process of migrating data between distributed FSs of different types within the same node 110 in the case where data stored in the nodes 110 by the migration source distributed FS 101 and the migration destination distributed FS 102 is managed by the common local file system section 521.

The migration source distributed FS 101 and the migration destination distributed FS 102 uses a common logical volume 1901.

A difference from the first embodiment is that a page release process is not executed on the logical volume 1901 of the migration source distributed FS 101. This is due to the fact that since a region allocated to a file deleted from the migration source distributed FS 101 is released and reused by the migration destination distributed FS 102 and the common local file system section 521, the page release process is not necessary for the logical volume.

The storage system 100 is basically the same as that described in the first embodiment (configurations illustrated in FIGS. 2, 3, 4, and 5).

A stub file is the same as that described in the first embodiment (refer to FIGS. 6 and 7).

The migration source management table 531 is the same as that described in the first embodiment (refer to FIG. 8). In the second embodiment, however, the distributed FS migration section 111 does not release a page, and thus the distributed FS migration section 111 does not reference the intra-node path 806 and logical LBA offset 807 of the migration source file management table 531.

The physical pool management table 551 is the same as that described in the first embodiment (refer to FIG. 9). The page allocation management table 552 is the same as that described in the first embodiment (refer to FIG. 10). In the second embodiment, however, the distributed FS migration section 111 does not release a page and thus does not reference the page allocation management table 552.

The migration management table 561 is the same as that described in the first embodiment (refer to FIG. 11). The migration file management table 562 is the same as that described in the first embodiment (refer to FIG. 12). The migration source volume release region management table 563 (illustrated in FIG. 13) is not necessary in the second embodiment. The node capacity management table 564 is the same as that described in the first embodiment (refer to FIG. 14).

The distributed FS migration process is the same as that described in the first embodiment (refer to FIG. 15). In the second embodiment, in the file migration process, steps S1606 and S1607 illustrated in FIG. 16 are not necessary. In the second embodiment, the page release process (illustrated in FIG. 17) is not necessary. Processes that are executed by the stub manager 113 and the migration destination distributed FS section 115 when the distributed FS server receives a file I/O request are the same as those described in the first embodiment (refer to FIG. 18).

### (3) Other Embodiments

Although the embodiments describe the case where the invention is applied to the storage system, the invention is not limited to this and is widely applicable to other various systems, devices, methods, and programs.

In the foregoing description, information of the programs, the tables, the files, and the like may be stored in a storage medium such as a memory, a hard disk, a solid state drive (SSD) or a recording medium such as an IC card, an SD card, or a DVD.

The foregoing embodiments include the following characteristic configurations, for example.

In a storage system (for example, the storage system 100) including one or more nodes (for example, the nodes 110), each of the one or more nodes stores data managed in the system (for example, the migration source distributed FS 101 and the migration destination distributed FS 102) and includes a data migration section (for example, the distributed FS migration section 111) that controls migration of the data (that may be blocks, files, or objects) managed in a migration source system from the migration source system (for example, the migration source distributed FS 101) configured using the one or more nodes (that may be all the nodes 110 of the storage system 100 or may be one or more of the nodes 110) to a migration destination system (for example, the migration destination distributed FS 102) configured using the one or more nodes (that may be the same as or different from the nodes 110 constituting the migration source distributed FS 101) and a data processing section (for example, the network file processing section 112 and the stub manager 113) that generates, in the migration destination system, stub information (for example, the stub information 720) including information (for example, a path name) indicating a storage destination of the data in the migration source system. The data migration section instructs the data processing section to migrate the data of the migration source system to the migration destination system (for example, in steps S1601 and S1602). When the data processing section receives the instruction to migrate the data, and the stub information of the data exists, the data processing section reads the data from the migration source system based on the stub information and instructs the migration destination system to write the data (for example, insteps S1801 to S1803) and deletes the stub information. When the migration of the data is completed, the data migration section instructs the migration source system to delete the data (for example, in step S1604).

In the foregoing configuration, data that is not yet migrated is read from the migration source system using stub information, and when the data is written to the migration destination system, the data is deleted from the migration source system. According to the configuration, the storage system can avoid holding duplicate data and migrate data from the migration source system to the migration destination source using an existing device, while a user does not add a device in order to migrate the data from the migration source system to the migration destination system.

The storage system manages data, and the data migration section manages an available capacity of the one or more nodes used for the migration source system and the migration destination system (in step S1503). The data migration section (A) selects data to be migrated based on the available capacity of the one or more nodes (in step S1601) and instructs the data processing section to migrate the data (in step S1602). The data migration section (B) instructs the migration source system to delete the data completely migrated (in step S1604) and (C) updates the available capacity of the one or more nodes from which the data has been deleted (in step S1608). The data migration section repeats (A) to (C) to control the data migration.

A plurality of the nodes exist and each of the nodes has a storage device (for example, a storage medium 304) for storing the data.

The migration source system and the migration destination system are distributed systems (for example, distributed block systems, distributed file systems, or distributed object systems) configured using the plurality of nodes.

According to the foregoing configuration, for example, an existing device can be used to migrate data of the migration source distributed system without adding a device to migrate the data from the migration source distributed system to the migration destination distributed system.

The migration source system and the migration destination system are distributed systems configured using the plurality of nodes, cause data to be distributed and stored in the plurality of nodes, and share at least one of the nodes (refer to FIGS. 1 and 19).

The data migration section selects, as data to be migrated, data stored in a node that has a small available capacity and is a storage destination in the migration source system (for example, in steps S1601 and S1602).

According to the foregoing configuration, for example, in a configuration in which the migration destination system causes data to be uniformly stored in the nodes, the number of times that input and output (I/O) fail due to an insufficient available capacity in the migration of the data can be reduced by migrating data from a node with a small available capacity.

Each of the one or more nodes includes a logical volume manager (for example, the logical volume manager 116) that allocates a page (for example, a physical page) of a logical device (for example, a physical pool 117) shared by the migration source system and the migration destination system to a logical volume (for example, the logical volumes 118 and 119). The data migration section provides an instruction to migrate the data in units of logical volumes. When the data migration section determines that all data of the page allocated to the logical volume (for example, the logical volume 118) used by the migration source system has been migrated to the migration destination system, the data migration section provides an instruction to release the page of the logical volume (for example, in steps S1701 and S1702).

According to the foregoing configuration, for example, even when the logical device is shared by the migration source system and the migration destination system, the page is released to avoid insufficiency of a capacity, and thus the data can be appropriately migrated.

The data migration section instructs the data processing section to migrate data (for example, to migrate a plurality of files or migrate files in units of directories).

According to the foregoing configuration, for example, overhead for the migration of data can be reduced by collectively migrating the data.

Each of the one or more nodes used for the migration source system and the migration destination system includes a storage device (for example, the storage array 305) and a logical volume manager (for example, the volume manager 116) that allocates a page (for example, a physical page) of a logical device (for example, a physical pool) of the storage device shared by the migration source system and the migration destination system to a logical volume (for example, the logical volumes 118 and 119). The data migration section provides an instruction to migrate the data in units of logical volumes. When the data migration section determines that all data of the page allocated to the logical volume used by the migration source system has been migrated to the migration destination system, the data migration section provides an instruction to release the page of the logical volume.

According to the foregoing configuration, for example, even when a logical device of shared storage is shared by the migration source system and the migration destination system, releasing the page can avoid insufficiency of a capacity, and the data can be appropriately migrated.

Units of the data managed in the migration source system and the migration destination system are files, objects, or blocks.

According to the foregoing configuration, for example, even when the migration source system and the migration destination system are files systems, object systems, or block systems, the data can be appropriately migrated.

Each of the foregoing one or more nodes includes a logical volume manager (for example, the logical volume manager 116) that allocates a page (physical page) of a logical device (for example, a physical pool 117) shared by the migration source system and the migration destination system to a logical volume (for example, the logical volume 1901) shared by the migration source system and the migration destination system, and a local system section (for example, the local file system section 521) that manages data of the migration source system and the migration destination system via the logical volume.

According to the foregoing configuration, for example, the data of the migration destination system and the migration source system is managed by the local system section, the page does not need to be released, it is possible to avoid insufficiency of the capacity, and thus the data can be appropriately migrated.

It should be understood that items listed in a form indicating “at least one of A, B, and C” indicates (A), (B), (C), (A and B), (A and C), (B and C), or (A, B, and C). Similarly, items listed in a form indicating “at least one of A, B, or C” may indicates (A), (B), (C), (A and B), (A and C), (B and C), or (A, B, and C).

Although the embodiments of the invention are described, the embodiments are described to clearly explain the invention, and the invention may not necessarily include all the configurations described above. A portion of a configuration described in a certain example may be replaced with a configuration described in another example. A configuration described in a certain example may added to a configuration described in another example. In addition, regarding a configuration among the configurations described in the embodiments, another configuration maybe added to, removed from, or replaced with the concerned configuration. The configurations considered to be necessary for the description are illustrated in the drawings, and all configurations of a product are not necessarily illustrated.

What is claimed is:

1. A storage system comprising one or more nodes, wherein
each of the one or more nodes stores data managed in the system and includes
a data migration section that controls migration of the data managed in a migration source system from the migration source system configured using the one or more nodes to a migration destination system configured using the one or more nodes, and
a data processing section that generates, in the migration destination system, stub information including information indicating a storage destination of the data in the migration source system,
the data migration section instructs the data processing section to migrate the data of the migration source system to the migration destination system,
when the data processing section receives the instruction to migrate the data, and the stub information of the data exists, the data processing section reads the data from the migration source system based on the stub information, instructs the migration destination system to write the data, and deletes the stub information, and
when the migration of the data is completed, the data migration section instructs the migration source system to delete the data.

2. The storage system according to claim 1, wherein
the storage system manages data,
the data migration section manages an available capacity of the one or more nodes used for the migration source system and the migration destination system,
the data migration section controls the migration of the data by repeatedly
(A) instructing the data processing section to select data to be migrated based on the available capacity of the one or more nodes and migrate the data,
(B) instructing the migration source system to delete the data completely migrated,
(C) updating the available capacity of the one or more nodes from which the data has been deleted.

3. The storage system according to claim 2, wherein
a plurality of the nodes exist, and each of the nodes has a storage device for storing the data.

4. The storage system according to claim 1, wherein
the migration source system and the migration destination system are distributed systems configured using a plurality of the nodes.

5. The storage system according to claim 3, wherein
the migration source system and the migration destination system are distributed systems configured using the plurality of nodes, cause data to be distributed and stored in the plurality of nodes, and share at least one of the nodes.

6. The storage system according to claim 2, wherein
the data migration section selects, as data to be migrated, data stored in a node that is a storage destination in the migration source system and whose available capacity is small.

7. The storage system according to claim 1, wherein
each of the one or more nodes includes a logical volume manager that allocates a page of a logical device shared by the migration source system and the migration destination system to a logical volume,
the data migration section provides an instruction to migrate the data in units of logical volumes, and
when the data migration section determines that all data of the page allocated to the logical volume used for the migration source system has been migrated to the migration destination system, the data migration section provides an instruction to release the page of the logical volume.

8. The storage system according to claim 4, wherein
each of the nodes used for the migration source system and the migration destination system includes a storage device,
each of the nodes includes a logical volume manager that allocates a page of a logical device of the storage device shared by the migration source system and the migration destination system to a logical volume,
the data migration section provides an instruction to migrate the data in units of logical volumes, and
when the data migration section determines that all data of the page allocated to the logical volume used for the migration source system has been migrated to the migration destination system, the data migration section provides an instruction to release the page of the logical volume.

9. The storage system according to claim 1, wherein
units of the data managed in the migration source system and the migration destination source are files, objects, or blocks.

10. The storage system according to claim 1, wherein
each of the one or more nodes includes a logical volume manager that allocates a page of a logical device shared by the migration source system and the migration destination system to a logical volume shared by the migration destination system and the migration source system, and a local system section that manages data of the migration source system and the migration destination system via the logical volume.

11. A data migration method to be executed in a storage system including one or more nodes, wherein
each of the one or more nodes stores data managed in the system and includes
a data migration section that controls migration of the data managed in a migration source system from the migration source system configured using the one or more nodes to a migration destination system configured using the one or more nodes, and
a data processing section that generates, in the migration destination system, stub information including information indicating a storage destination of the data in the migration source system,
the method comprises:
causing the data migration section to instruct the data processing section to migrate the data of the migration source system to the migration destination system;
causing, when the data processing section receives the instruction to migrate the data and the stub information of the data exists, the data processing section to read the data from the migration source system based on the stub information, instruct the migration destination system to write the data, and delete the stub information; and
causing, when the migration of the data is completed, the data migration section to instruct the migration source system to delete the data.
